(19) United States
(12) Patent Application Publication
(10) Pub. No.: US 2024/0346103 A1
(43) Pub. Date: Oct. 17, 2024

(54) SMART ZONE SELECTOR

(71) Applicant: Content Square SAS, Paris (FR)

(72) Inventors: Charif Chaibainou, Paris (FR); Gregory Riberon, Paris (FR)

(21) Appl. No.: 18/632,779

(22) Filed: Apr. 11, 2024

Related U.S. Application Data
(60) Provisional application No. 63/458,646, filed on Apr. 11, 2023.

(51) Int. Cl. G06F 16/957; G06F 16/901; G06F 40/279

(52) U.S. Cl. CPC G06F 16/9577; G06F 16/9027; G06F 40/279

(57) ABSTRACT

The subject technology receives a snapshot of a webpage. The subject technology identifies a first set of targets included in the snapshot. The subject technology selects nodes corresponding to the identified first set of targets. The subject technology determines, based on a selected metric, metrics for the selected nodes. The subject technology determines a second set of nodes by filtering a number of nodes having a highest set of values of the metrics. The subject technology generates a first set of zones based on the second set of nodes. The subject technology provides the generated first set of zones for display on a client device.

### PRIORITY CLAIM

This application claims the benefit of priority of U.S. Provisional Patent Application No. 63/458,646, filed Apr. 11, 2023, which is hereby incorporated by reference herein in its entirety for all purposes.

### BACKGROUND

As retailers, service providers, and other operators of online platforms continue to expand and improve the content made available through user-facing web services, the complexity of the webpages grows as well. The continued development of web-focused content provides site operators with additional avenues by which to connect with users, but also increases the likelihood of web errors. Such web errors may cause significant challenges for website operators, reducing user engagement, revenues, and the like, which may, in turn, harm the operator's business. As a result, website owners, operators, and administrators may seek to better understand the development of a webpage throughout its lifecycle. Further, the same interested parties may seek means to isolate fully-functional webpage versions in order to improve upon the successes thereof.

While a variety of factors may be of interest to webpage owners, operators, and administrators seeking to improve site performance, the isolation of key factors may provide a streamlined web-improvement process. In order to understand which elements of a webpage function as intended and which do not, interested parties may seek zone-analysis tools in order to easily discretize and identify the components of a webpage. While zone analysis may be achieved manually, by collection and labelling of individual webpage zones or elements, such a manual process may be time-consuming where a webpage includes many content elements or zones.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an experience analytics system, in accordance with some examples, that has both client-side and server-side functionality.

FIG. 3 is a diagrammatic representation of a data structure as maintained in a database, in accordance with some examples.

FIG. 4 is an example of a webpage with different zones, in accordance with an embodiment.

FIG. 5A is an example of a data structure in which different zones are represented, in accordance with an embodiment.

FIG. 5B is an example of a data structure in which different zones are represented, in accordance with an embodiment.

FIG. 6 illustrates a process in accordance with one embodiment.

FIG. 7 illustrates a process in accordance with one embodiment.

FIG. 8 is a diagrammatic representation of a machine in the form of a computer system within which a set of instructions may be executed for causing the machine to perform any one or more of the methodologies discussed herein, in accordance with some examples.

FIG. 9 is a block diagram showing a software architecture within which examples may be implemented.

### DETAILED DESCRIPTION

Embodiments of the subject technology perform automatic selection of zones on a given webpage based on a selected metric (e.g., click rate, recurrence, revenue, attractiveness rate, and the like). The webpage includes a set of targets, which may correspond to different elements on the webpage. Metrics, corresponding to the selected metric, of the set of targets are determined, and the subject technology filters the targets to identify a subset of targets with the highest values of metrics for the selected metric. Based on the filtered targets, the subject technology can select (e.g., generate) zones for the webpage in an automated manner (e.g., forgoing manual selection of zones by a user) that correspond to high(er) performing zones.

Webpage zones or simply “zones” as referred to herein are various content elements, fields, and the like, which, in combination, form the user-facing portions of a webpage or website. Such zones may be features of common web technologies such as Hypertext Markup Language (HTML) and Cascading Style Sheets (CSS), and may provide for user interactions with a website or webpage. As an example, an online retailer's page may include zones or elements allowing users to search for products (e.g., search bar), to add products to a digital shopping cart, to contact a retailer's support specialist via a chat popup, and the like. In an example, an online shopping website may include a search bar, a “go to cart” button, and a “home page” button, where the search bar and the various buttons are each different webpage zones. Other examples of zones, and the application and analysis thereof, are described herein.

As referred to herein, targets can correspond to webpage zones or elements with which, during the course of a session, a user is recorded interacting once or more. Targets may be identified by analysis of events included in snapshots of webpages. Targets may include, as examples and without limitation, buttons, fields, and other, like, webpage zones or elements. In an example, user interactions (which metrics are based upon) are based on the targets of the various interactions, such as hyperlinks, data entry fields, and the like.

### Networked Computing Environment

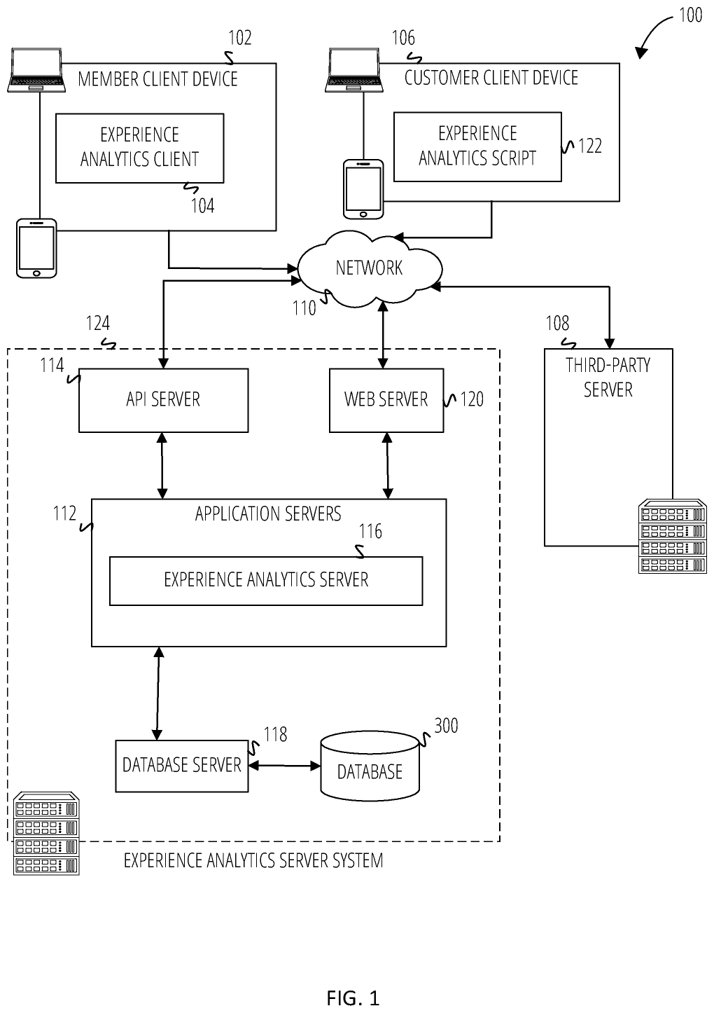

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client's third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client's websites that are hosted on the third-party servers 108 via the network 110 using the Internet browsing applications. For example, the users of the customer client device 106 can navigate to a client's online retail website to purchase goods or services from the website. While the user of the customer client device 106 is navigating the client's website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client's website and processed by the Internet browsing application on the customer client device 106. The experience analytics script 122 can incorporate a scripting language (e.g., a .*js file or a .json file).

In certain examples, a client's native application (e.g., ANDROID™ or IOS™ Application) is downloaded on the customer client device 106. In this example, the client's native application including the experience analytics script 122 is programmed in JavaScript leveraging a Software Development Kit (SDK) provided by the experience analytics server system 124. The SDK includes Application Programming Interfaces (APIs) with functions that can be called or invoked by the client's native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

In an embodiment, experience analytics script 122 can be implemented as a tracking tag, which is a snippet of JavaScript code that collects and sends data for analytics from a given web site. As referred to herein, the tracking tag can be understood as performing operations for gathering information or determining metrics related to user experience analytics (UXA).

In an example, the following code statements can be embedded in a given webpage to execute a tracking tag:

<script type=“text/javascript”> (function( ) { var mt =
document.createElement(“script”); mt.type = “text/javascript”; mt.async = true; mt.src
=
“//t.cs.net/uxa/<YOUR_TAG_ID>.js”; document.getElementsByTagName(“head”)[0].ap
pendChild(mt); })( ); </script>

In an example, the above code statements creates a function that adds an asynchronous call to a script and then executes the function. In this manner, other elements loading can be avoided from being blocked on the webpage. This can reduce the impact of the tracking tag on the web site's performance.

In an example, the tracking tag includes 1) an object gathering configuration elements of an account, such as used domain, inclusion percentages, and the like, and 2) a newest version of the tracking tag library.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, feedback provided by the user into feedback forms or widgets on the website, etc. Other processor and memory intensive processing of data may also be performed server-side by the experience analytics server 116, in view of the hardware requirements for such processing.

### System Architecture

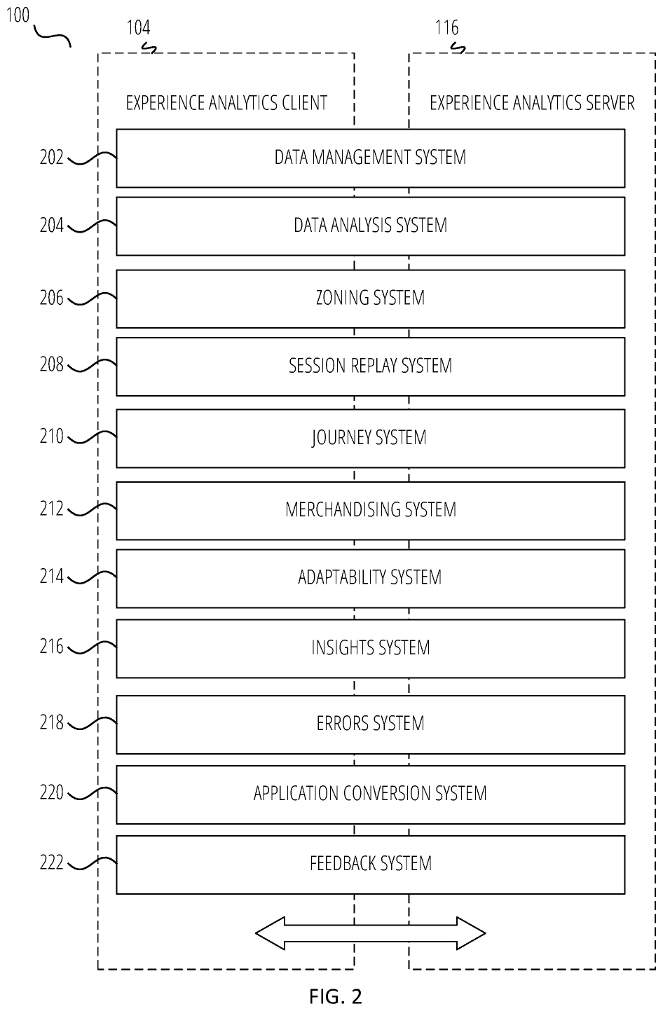

FIG. 2 is a block diagram illustrating further details regarding the experience analytics system 100 according to some examples. Specifically, the experience analytics system 100 is shown to comprise the experience analytics client 104 and the experience analytics server 116. The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

In an implementation, data analysis system 204 determines various metrics based on an analysis of data received by the data management system 202. Metrics in some examples are quantifications of goal-related site interactions such as, as examples, and without limitation, the time which a given user spends hovering over a product image on a retail website. Goals, for which various metrics may be more or less applicable, refer to predefined or user-defined website objectives. For each goal, one or more metrics may be applicable. As an example, a user-defined goal may be to reduce the percentage of site visitors who end a site visit without viewing a “cart” page below a defined threshold. In the same example, goal-related metrics may include percentages of users who click a “cart” button, percentages of users who click an “add item to cart” button, and the like.

Metric tracking may be configured through one or more configuration tools, such as included in a web platform accessible through a browser, in a designated administrative terminal, in an application (e.g., mobile app) installed on a user device, and the like. Metric tracking may be implemented by inclusion of an experience analytics script 122 (as discussed before) in a webpage's underlying code.

Additional examples of metrics are described herein. In particular, metrics discussed further herein include click rate, click recurrence, revenue, and attractiveness rate, which are further described in the following discussion.

Click rate is a calculation of the number of page views where a zone was clicked divided by the total number of page views. This metric determines how many site visitors clicked at least once on a zone (or in-page element) for each page view.

Click recurrence represents the average number of times a zone was clicked when engaged with during a pageview. This metric can indicate engagement or frustration. For example, a high click recurrence on a carousel is a positive sign, as it shows a high engagement with an target offering many clickable areas.

Revenue can refer to zone revenue data indicating a revenue contribution of a corresponding zone. Zone revenue data may include, as an example, a total revenue generated in a given session in a given zone, zone revenue data collected during a specified date range in a given zone, and the like. Such zone revenue data can be based on determining aggregate revenues generated by each session including an interaction with a given zone, the contribution of each zone for a specific day or a range of dates, and the like, including any combination thereof of the aforementioned. As an example, where zone revenue data includes five sessions, each including a generated revenue value of $500 USD, and each including an interaction with a “proceed to checkout” button, zone revenue data analysis by data analysis system 204 may include the attribution of $2,500 USD in revenue to the “proceed to checkout button.”

An attractiveness rate indicates a percentage of visitors who clicked on a zone after having been exposed to it. In one example, the attractiveness rate is a percentage of times a user(s) selects a product image or other references (e.g., text links) to a specific product, when the user navigated by scrolling through a webpage to a zone. In an example, the attractiveness rate informs a webpage administrator on optimizing the placement of content on the webpage. A high rate indicates a high performing attractiveness of a zone (or target within the zone).

The zoning system 206 is responsible for generating a zoning interface to be displayed by the member client device 102 via the experience analytics client 104. The zoning interface provides a visualization of how the users via the customer client devices 106 interact with each element on the client's website. The zoning interface can also provide an aggregated view of in-page behaviors by the users via the customer client device 106 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the member client device 102. In one example, the data can be generated using information from the data analysis system 204.

In embodiments described herein, zoning system 206 can automatically select (or generate) zones within a given webpage based at least in part on a selected metric. In an example, a user can select a given metric using the aforementioned zoning interface that serves as the basis for automatic zone selection. Based on the selected metric, zoning system 206 receives a set of metrics from data analysis system 204 that correspond to a predetermined number of zones including the top performing zones for the selected metric. In an example, the number of zones can be a number such as ten, where such ten zones correspond to the top ten zones for the selected metric.

In an embodiment, zoning system 206 receives a set of snapshots for a given webpage. A snapshot can include code that is extracted from a webpage where such code may be any programming language code utilized to design or run webpages. Examples for such languages may include hypertext markup language (HTML), JavaScript, CSS, Python, PHP, SQL, and the like. Without limiting the scope of the disclosed embodiments, such code will be referred to an “HTML code.” HTML code may be extracted by downloading web data from a web server, such the client's third-party server 108, where the web data may include whole webpages, webpage HTML code, webpage document object models (DOMs), and the like, and any combination thereof. The underlying code of the various webpages, as extracted, may be structured as a “snapshot,” with each snapshot including the code underlying a webpage at the instant of extraction, a time or date stamp recording the date of extraction, a URL tag describing the URL of the extracted webpage, and other, like, data features. Moreover, a snapshot ID can be associated with a given snapshot where the snapshot ID is a data element, such as tag or label, providing unique identification of a given webpage's underlying HTML code at the instant at which the webpage was accessed or captured. In an implementation, each snapshot of a webpage is represented as a set of nodes for targets in the webpage.

In an embodiment, elements may be identified in a webpage's code by application of techniques including, without limitation, natural language processing (NLP), and the like. In the application of NLP techniques to the identification of elements in the webpage's code, the code underlying the website may be analyzed as text, with characters, strings, or other text features serving to identify zones or elements.

In an example, the HTML code for a given webpage may include code within a “header” section, defined by a specific header tag. In an example, the header section may be defined by a first tag and a second tag marking the beginning and end of the header section. Additionally, the contents of a given section, marked by tags, as described above, may be further sub-sectioned such that a first section may include a number of subsections (e.g., a first subsection, second subsection, and third subsection, and the like), each containing various (potential) targets that can be identified.

In an embodiment, data analysis system 204 determines a set of metrics for targets of a given webpage. In this context, a target refers to an identifier for a webpage node, such as an HTML node, or a corresponding DOM (Document Object Model) node of a webpage. For example, a webpage can be represented as a set of nodes where such nodes may include HTML nodes, or relate to DOM nodes where each DOM node corresponds to a given HTML element or zone in a webpage in an example. For a webpage, a data structure (e.g., tree) including a set of nodes corresponding to a set of targets can be determined. In an example, a node from this data structure can correspond to a webpage element or zone, and the node can include one or more node properties or features including, without limitation, zone or element positions, zone information (if any), and the like, as well as any combination thereof.

In an implementation, data analysis system 204 receives a set of snapshots of a webpage (e.g., from zoning system 206 or provided by snapshot table 318 discussed further below). In an example, the set of nodes may include from 10,000 to 20,000 nodes. For the set of nodes, data analysis system 204 computes metrics corresponding to the selected metric discussed above. Next, data analysis system 204 filters the set of nodes to only include a remaining set of nodes that represent a set of top performing nodes based on the computed metrics. In an example, the set of top performing nodes represent a top ten (or other number) of highest performing nodes within the webpage. In an embodiment, the zoning system 206 can perform the filtering instead of the data analysis system 204. The zoning system 206 receives the filtered set of nodes, and determines a set of zones corresponding to the nodes. Further, zoning system 206 provides for display an interface representing the set of zones, which can be viewed by a user of member client device 102.

In an implementation, data analysis system 204 performs a pre-filtering process for reducing a number of metrics that are computed for nodes included in a given webpage. For example, data analysis system 204 determines a set of targets corresponding to a highest number of clicks. This can be accomplished by the data analysis system 204 computing a number of clicks for the nodes in the webpage, and determining a set of remaining nodes (e.g., corresponding to targets) that are associated with a highest number of clicks among all of the nodes (e.g., top 100 nodes with the highest number of clicks). For this set of remaining nodes, data analysis system 204 can proceed to compute metrics based on the selected metric as described above.

In an example, zoning system 206 can mark or annotate a set of nodes from a snapshot of a given webpage to indicate which nodes are targets, and subsequently provides all targets of the webpage in a compressed way, e.g., as a string tree instead of a plain list of targets, thereby at least providing further compression or storage savings.

The session replay system 208 is responsible for generating the session replay interface to be displayed by the member client device 102 via the experience analytics client 104. The session replay interface includes a session replay that is a video reconstructing an individual user's session (e.g., visitor session) on the client's website. The user's session starts when the user arrives into the client's website and ends upon the user's exit from the client's website. A user's session when visiting the client's website on a customer client device 106 can be reconstructed from the data received from the user's experience analytics script 122 on customer client devices 106. The session replay interface can also include the session replays of a number of different visitor sessions to the client's website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website and illustrates the visited pages in the order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on: the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's website to be displayed by the customer client devices 106 for visitors that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client's website is needed, and can generate the accessibility-enhanced version of the client's website to be displayed by the customer client device 106.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey in the website and the page that adversely affects (e.g., causes frustration for) the users (e.g., users on customer client devices 106 visiting the client's website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client's website to a client's native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client's mobile application to be displayed by the customer client devices 106.

The feedback system 222 is responsible for receiving and analyzing data from the data management system 202 that includes the feedback data received from the client devices. As the visitor progresses through a client's website on the client device, a feedback webpage of the website, a pop-up window or tab, or an overlay can be displayed to receive the visitor's feedback. For instance, a feedback form can be displayed in a pop-up window or tab of the website, an overlay of the website, one of the plurality of webpages of the website, etc. The visitor can provide feedback on, for example, the functionality of the website, aesthetics of the website, on the goods and services associated with the website, etc. The feedback data can include a text input that is included into a feedback form on the website. The feedback data can also include a survey response, a rating that includes an image, an emoticon, or an icon, a screenshot of one of the plurality of webpages, etc. The feedback system 222 is also responsible for generating feedback interfaces to be displayed by the member client device 102 via the experience analytics client 104.

### Data Architecture

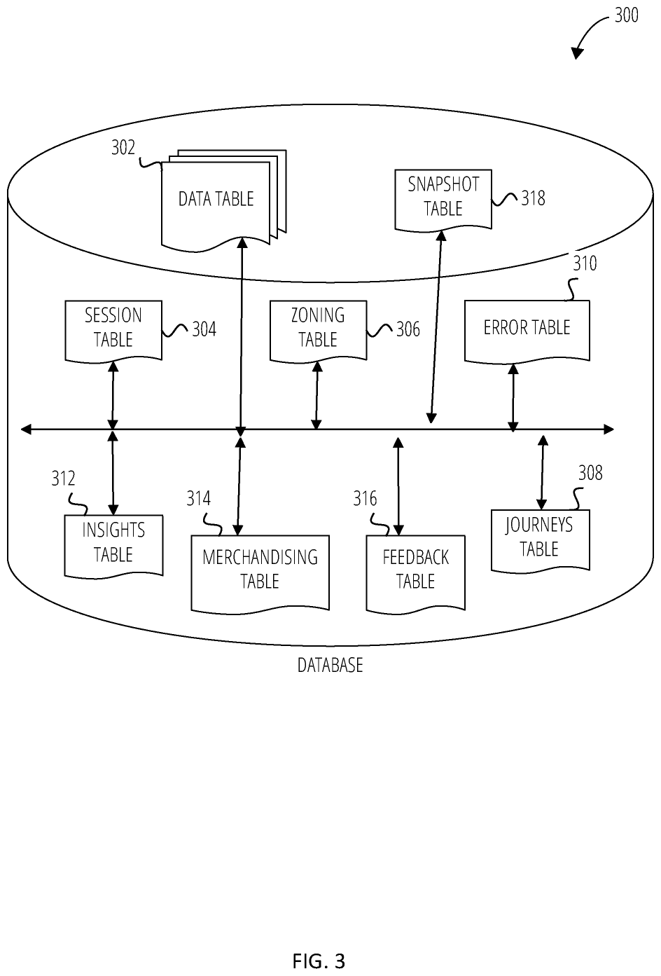

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, a journeys table 308, and a snapshot table 318.

The data table 302 stores data regarding the websites and native applications associated with the clients of the experience analytics system 100. The data table 302 can store information on the contents of the website or the native application, the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications.

The zoning table 306 stores data related to the zoning for each of the client's websites and native applications including the zones to be created and the zoning overlay associated with the websites and native applications.

The journeys table 308 stores data related to the journey of each visitor to the client's website or through the native application.

The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

The feedback table 316 stores data associated with the feedback system 222. For example, the data in the feedback table 316 can include the feedback data received from each of the customer client devices 106 and stored in association with the customer client device 106 and the website associated with the customer client device 106. The feedback data can include, for example, the text input that provides the visitor's (or customer's) feedback on the website, survey response, rating that includes an image, an emoticon, or an icon, a screenshot of one of the plurality of webpages, etc.

The snapshot table 318 stores data associated with snapshots for automatic zone selection as discussed above in connection with at least FIG. 2.

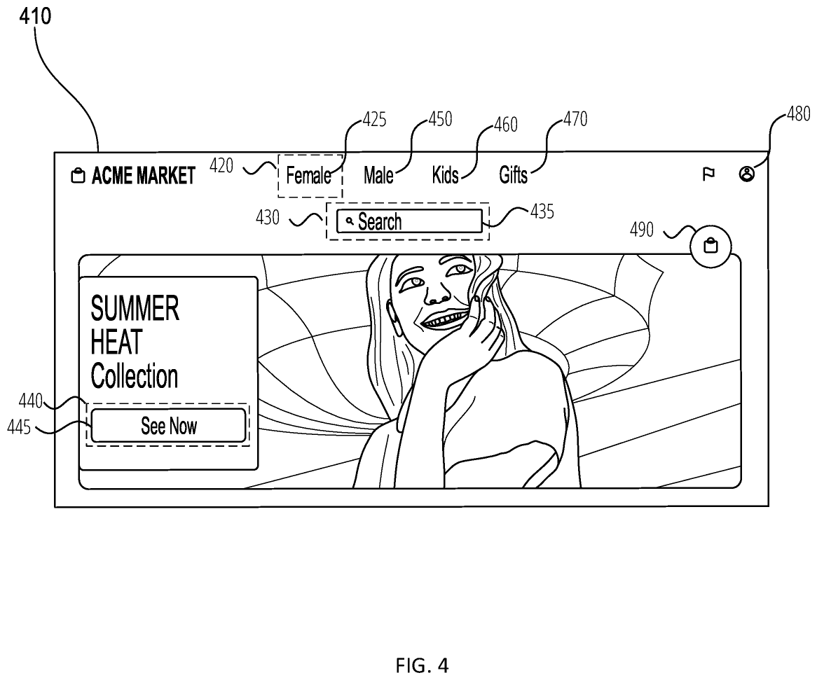

FIG. 4 illustrates an example webpage with different zones in accordance with one embodiment. As mentioned before, targets can correspond to webpage zones or elements with which, during the course of a session, a user is recorded interacting once or more. Further, various metrics (e.g., a selected metric(s) such as click rate, click recurrence, revenue, attractiveness rate, and the like) may be determined for a given target(s), which is discussed further herein.

In the example of FIG. 4, webpage 410 includes target 425, target 435, and target 445, each target corresponding to a particular element of webpage 410. Each of the aforementioned targets correspond, respectively, to zone 420, zone 430, and zone 440 (discussed further below) in this example. In an embodiment, a target refers to a path within a HTML tree (e.g., the DOM of the webpage) that defines a zone. Thus, although each zone is illustrated as surrounding its corresponding target in FIG. 4 to facilitate explanation, it is understood that in one embodiment a zone and a target refer to the same element in the webpage 410.

As an illustration, zoning system 206 receives a set of snapshots for a given webpage (e.g., webpage 410) where each snapshot corresponds to a session(s) of a given user(s). As mentioned before, a snapshot can include code that is extracted from a webpage where such code may be any programming language code utilized to design or run webpages. In an implementation, each snapshot of a webpage is represented as a set of nodes for targets in the webpage. Such a set of nodes may correspond to a document object model (DOM) tree describing the given webpage (e.g., webpage 410). However, it is appreciated that another hierarchical data structure may be utilized instead of the DOM tree, and still be within the scope of the subject technology.

As also discussed before, data analysis system 204 determines a set of metrics for targets of the webpage, such as webpage 410. In this context, a target refers to an identifier for a webpage node, such as an HTML node, or a corresponding DOM (document object model) node of a webpage. For example, a webpage can be represented as a set of nodes where such nodes may include HTML nodes, or relate to DOM nodes where each DOM node corresponds to a given HTML element or zone in a webpage in an example. For a webpage, a data structure (e.g., tree) including a set of nodes corresponding to a set of targets can be determined. In an example, a node from this data structure can correspond to a webpage element or zone, and the node can include one or more node properties or features including, without limitation, zone or element positions, zone information (if any), and the like, as well as any combination thereof.

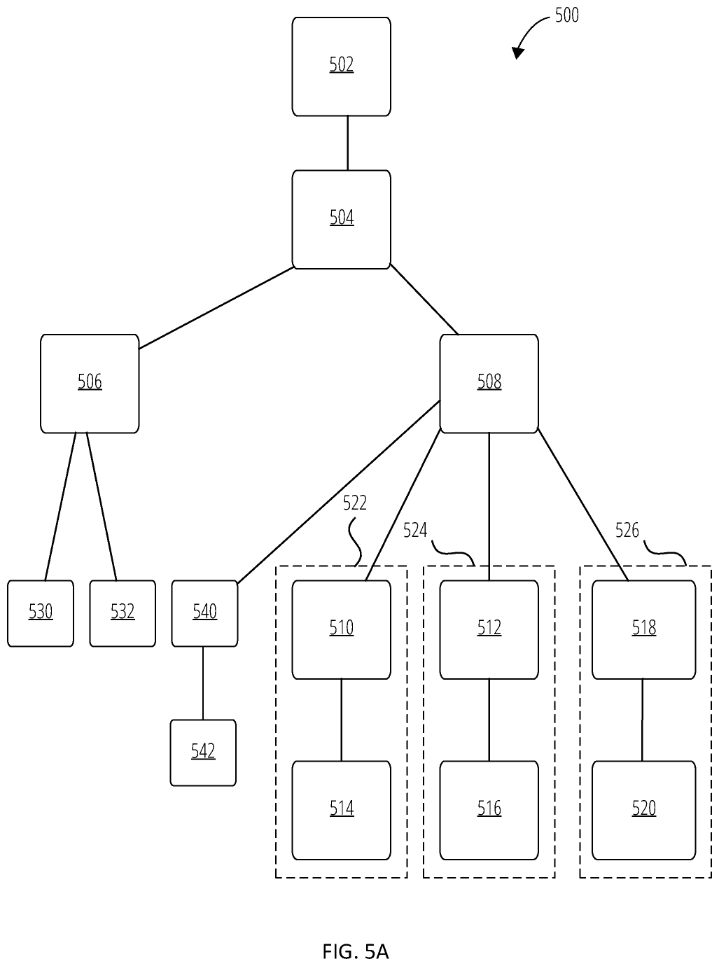

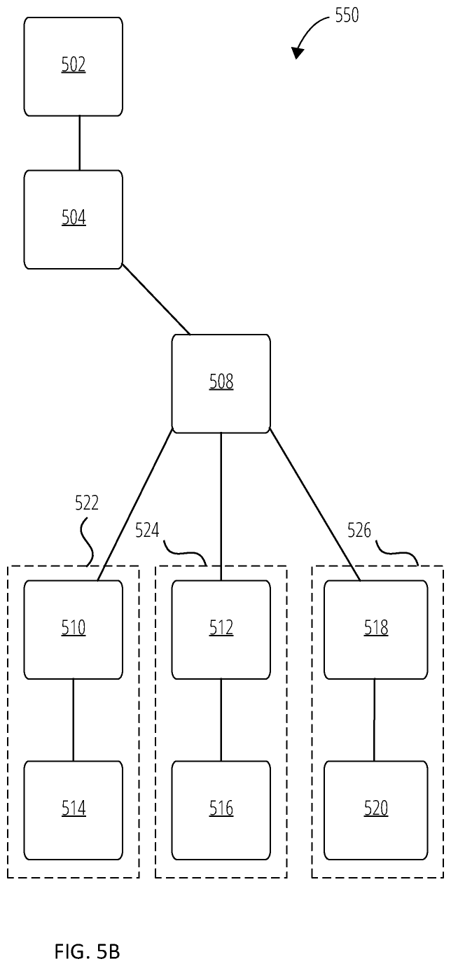

As described with respect to FIG. 5A and FIG. 5B below, a DOM tree may provide a hierarchical description of the elements of a webpage and the various sections and subsections of the webpage to which those elements belong. Identified elements (e.g., some of which corresponding to various targets) may be represented in the DOM tree as different nodes in a hierarchical structure.

In an example, zoning system 206 can identify targets included in a snapshot of a given webpage. Based on a selected metric, zoning system 206 receives a set of metrics from data analysis system 204, which in turn can be analyzed to generate a set of zones including a number of top performing zones for the selected metric. Each zone from the generated set of zones includes a target with an associated metric for the selected metric.

As shown, zone 420 corresponds to a particular target (e.g., target 425), where such a target corresponds to a particular element (e.g., “Female” menu item) of a menu interface. As also shown, zone 430 corresponds to a target (e.g., target 435) corresponding to an element (e.g., search bar). Further, zone 440 corresponds to a target (e.g., target 445) corresponding to an element (e.g., button with “See Now” text). In an example, a zone is a target, and a zone can include an element and all of the “children” elements of that element (e.g., child nodes in the DOM tree).

As also shown, webpage 410 includes target 450, target 460, target 470, target 480, and target 490, each of which correspond to a particular element(s) of webpage 410. In the example of FIG. 4, although such targets are visible on webpage 410, and each target can (potentially) correspond to a respective zone within webpage 410, the aforementioned targets are not determined as being part of the top performing zones for a selected metric. In this example, each of target 450, target 460, target 470, target 480, and target 490 may not have a value of the selected metric that is sufficient to qualify as one of the number of top performing zones for the selected metric based on for example a threshold value (e.g., greater than a particular value for the selected metric), or a predetermined number of targets with the greatest values of the selected metric are to be selected as one of the top performing zones.

It is appreciated that other types of targets (or zones) can be identified for a given webpage, and the examples in FIG. 4 are provided for the sake of illustrating aspects of the subject technology but are not necessarily exhaustive in discussion of all possible targets, zones, or elements shown in webpage 410.

FIG. 5A illustrates an example hierarchical data structure that is a representation of the example webpage of FIG. 4, in accordance with one embodiment. Although a document object model tree is discussed in connection with FIG. 5A (and FIG. 5B further below) for the purposes of illustration, it is appreciated that another appropriate data structure may be utilized and still be within the scope of the subject technology.

FIG. 5A is an example diagram depicting a (unlabeled) document object model (DOM) tree 500, according to an embodiment. The DOM tree 500 provides a visual representation of the hierarchical structure of a webpage's HTML code (e.g., webpage 410), with zones or elements represented as nodes 502, 504, 506, 508, 510, 512, 514, 516, 518, 520, 530, 532, 540, and 542. In the example DOM tree 500, related nodes are joined by links, indicating a relationship between two nodes.

In DOM tree 500, node 502 corresponds to a root node of the tree and node 504 is a direct child below node 502. In an example, node 504 can represent a root element of the web page. As further shown, node 506 and node 508 are positioned in a tier below node 504, which indicates a structure in which the element represented by node 504 includes the elements represented by nodes 506 and 508.

Node 530 and node 532 are positioned below node 506 and, again, indicates the element represented by node 506 includes the elements represented by nodes 530 and 532.

As also shown, node 510, node 514, node 512, node 516, node 518, node 520, node 540, and node 542 are positioned below the element or zone represented by node 508, and indicate the element (or zone) represented by node 508 includes the elements or zones represented by the aforementioned below nodes.

In an example, data management system 202 determines values for the selected metric (e.g., selected using zoning system 206 corresponding to click rate, click recurrence, revenue, attractiveness rate, and the like) for at least some (if not all) of the aforementioned nodes. Zones may be automatically generated (e.g., by zoning system 206) for targets within the webpage based on the determined values of the selected metric. In this example, zone 522, zone 524, and zone 526 are generated based on values of the selected metric where each zone includes respective nodes that correspond to various targets (e.g., elements from webpage 410) that indicate a top performing zone. In the example of DOM tree 500, node 510 and node 514 are included in a zone 522, node 512 and node 516 are included in a zone 524, and node 518 and node 520 are included in a zone 526. Each of the aforementioned nodes can correspond to a particular target and an associated value of the selected metric that indicate a top performing zone within the webpage. As mentioned before, a target refers to a path within a HTML tree (e.g., the DOM of the webpage) that defines a zone, and therefore the zone is the target in which the zone can include an element (e.g., a particular node) and all of the “children” elements (e.g., child nodes) of that element. Thus in FIG. 5A, zone 522 corresponds to a first target in which zone 522 includes node 510 and node 514, zone 524 corresponds to a second target where zone 524 includes node 512 and node 516, and zone 526 corresponds to a third target wherein zone 526 includes node 518 and node 520.

Based on the determined values of the selected metric, node 540 and node 542 may correspond to a target that is not within a (potential) top performing zone based on a value(s) of the selected metric for these nodes. On the other side of DOM tree 500, node 506 and its child node 530 and node 532 may also correspond to a target is also not associated with values of the selected metric that would indicated a top performing zone(s). Moreover, one or more of the aforementioned nodes may be determined as not being a valid target of the web page (e.g., webpage 410) and therefore values of the selected metric may not have been able to be determined. For these aforementioned nodes, zones are not automatically generated (e.g., to indicate a top performing zone).

As discussed further below in FIG. 5B, various nodes, including the aforementioned nodes, can be filtered based on determining values of the selected metric for the nodes (e.g., when the values do not indicate a top performing zone), or when a target is not considered a valid one (e.g., based on factors such as an element being included in the DOM tree but being unable to be interacted with by a user during a session such as in the case of being a hidden or invisible element on the webpage).

By reference to FIG. 4, in an example, zone 420 corresponds to zone 522, zone 430 corresponds to zone 524, and zone 440 corresponds to zone 526.

In an embodiment, the DOM tree 500 can be filtered to compress or reduce an amount of data included in such a DOM tree based on the automated generation of zones mentioned before. Such filtering is at least advantageous to improve the functionality of a computer (e.g., experience analytics client 104, experience analytics server 116) as an amount of data included in the DOM tree is reduced thereby resulting in reducing processing time, network bandwidth usage, and storage/memory utilization. A discussion of such filtering follows below in FIG. 5B.

FIG. 5B illustrates an example hierarchical data structure that is a representation of the example webpage of FIG. 4, in accordance with one embodiment.

As mentioned before, DOM tree 500 can be filtered to reduce the size (e.g., amount of data) of the final DOM tree, which results in increased performance and improvements in the functionality of a given computer (e.g., experience analytics client 104, experience analytics server 116, and the like).

As shown in the example of FIG. 5B, DOM tree 550 is a filtered version of DOM tree 500 discussed in FIG. 5A after DOM tree 500 has undergone filtering to remove nodes that are not corresponding to top performing targets (or not valid targets) included in webpage 410. By reference to FIG. 5A, node 540, node 542, node 506, node 530, and node 532 have been removed (e.g., filtered) from being included in DOM tree 550.

In an implementation, zoning system 206 determines which nodes to filter based determining a number of nodes having a highest set of values of the metrics. In this example, zone 522, zone 524, and zone 526 include targets that are associated with the highest set of values of the selected metric. Thus, node 510 and node 514 of zone 522, node 512 and node 516 of zone 524, and node 518 and node 520 of zone 526 are associated with targets within webpage 410 associated with top performing zones (e.g., zone 522, zone 524, and zone 526). As mentioned before, node 540, node 542, node 506, node 530, and node 532 have been removed (e.g., filtered) from being included in DOM tree 550.

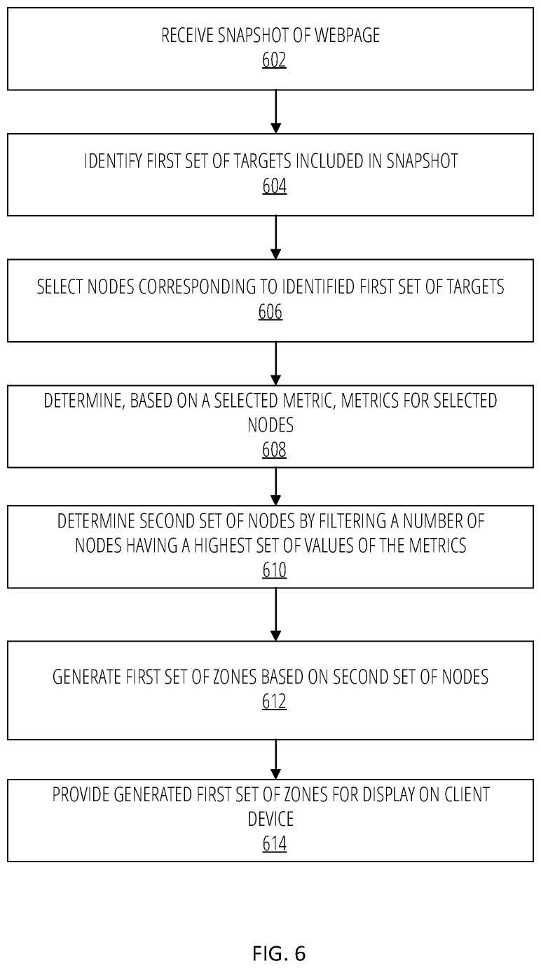

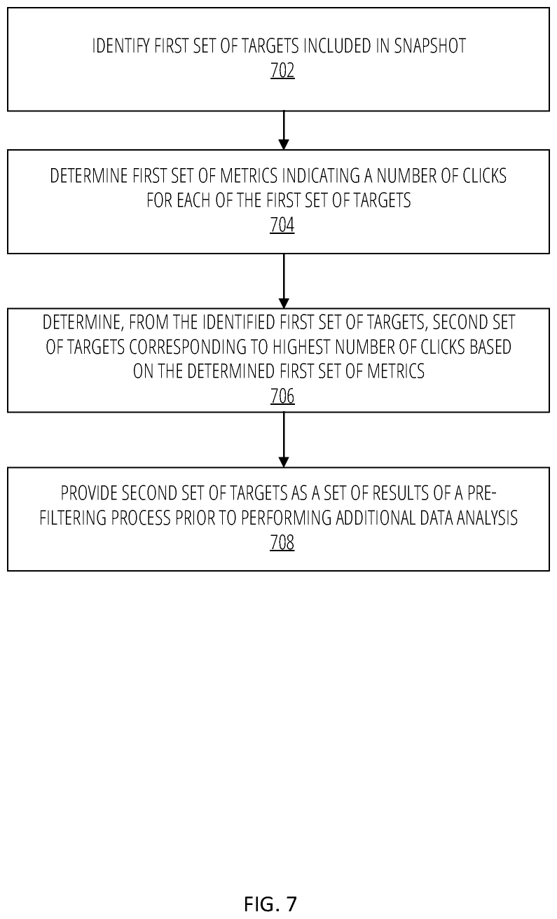

The following discussion of FIG. 6 and FIG. 7 relates to example processes represented as flowchart(s). Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

FIG. 6 illustrates a process in accordance with one embodiment. As discussed below, zoning system 206 and data management system 202 are described as performing operations of process.

At operation 602, zoning system 206 receives a snapshot of a webpage.

At operation 604, zoning system 206 identifies a first set of targets included in the snapshot. In an embodiment, identifying the first set of targets included in the snapshot is based on a natural language processing process that identifies a set of elements from the snapshot.

At operation 606, zoning system 206 selects nodes corresponding to the identified first set of targets.

At operation 608, data management system 202 determines, based on a selected metric, metrics for the selected nodes. In an embodiment, the selected metric comprises a click rate, click recurrence, revenue, or attractiveness rate.

At operation 610, zoning system 206 determines a second set of nodes by filtering a number of nodes having a highest set of values of the metrics. In an embodiment, filtering the number of nodes having the highest set of values of the metrics comprises removing a third set of nodes from the selected nodes, the third set of nodes having values of the selected metric that are lower than each value from the highest set of values, the second set of nodes corresponding to a set of remaining nodes after removing the third set of nodes.

At operation 612, zoning system 206 generates a first set of zones based on the second set of nodes. In an embodiment, generating the first set of zones includes assigning a tag or metadata comprising information identifying each zone from the first set of zones.

At operation 614, zoning system 206 provides the generated first set of zones for display on a client device. In an embodiment, providing the generated first set of zones for display on a client device comprises generating an interface, the interface comprising a set of graphical elements representing the generated first set of zones, the set of graphical elements comprising visual indicators that highlight a set of positions of the generated first set of zones within the webpage.

In an embodiment, zoning system 206 generates a tree structure representing the first set of targets included in the snapshot, the tree structure comprising a set of nodes, the set of nodes comprising a particular node for each target from the first set of targets.

FIG. 7 illustrates a process in accordance with one embodiment. As discussed below, zoning system 206 and data management system 202 are described as performing operations of process.

At operation 702, data management system 202 identifies the first set of targets included in the snapshot.

At operation 704, data management system 202 determines a first set of metrics indicating a number of clicks for each of the first set of targets.

At operation 706, data management system 202 determines, from the identified first set of targets, a second set of targets corresponding to a highest number of clicks based on the determined first set of metrics.

At operation 708, data management system 202 provides the second set of targets as a set of results of a pre-filtering process prior to performing additional data analysis.

In an embodiment, zoning system 206 selects a particular set of nodes corresponding to the identified first set of targets, and determines a second set of metrics for the particular set of nodes, the second set of metrics comprising a particular metric different from the selected metric.

In an embodiment, zoning system 206 generates a second set of zones based on the particular set of nodes, and provides the generated second set of zones for display on the client device.

### Machine Architecture

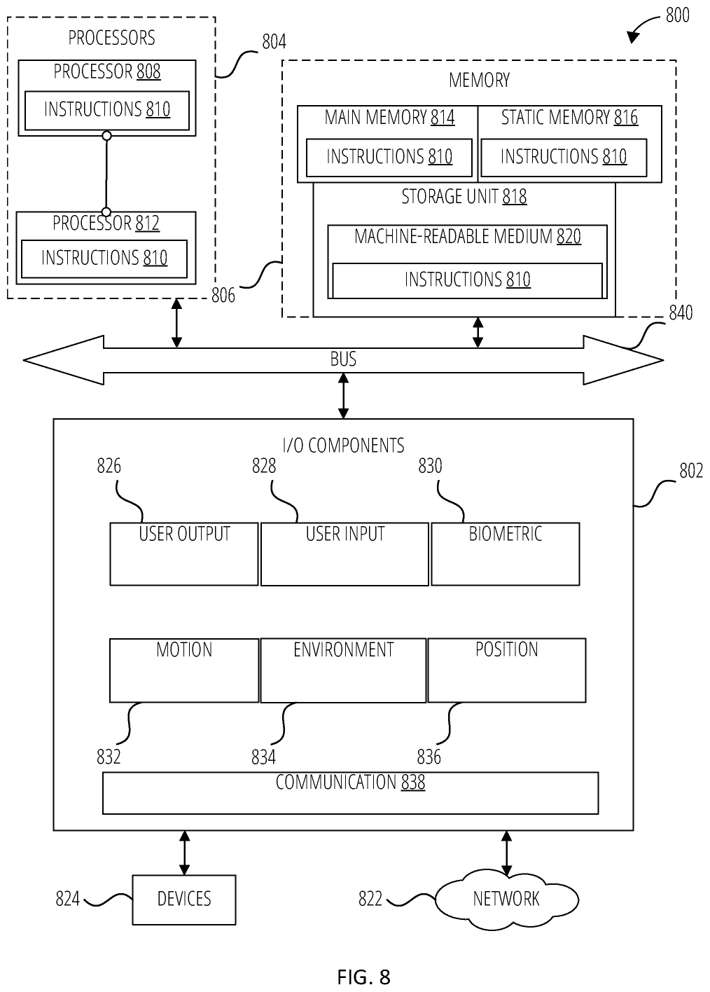

FIG. 8 is a diagrammatic representation of the machine 800 within which instructions 810 (e.g., software, a program, an application, an applet, an application, or other executable code) for causing the machine 800 to perform any one or more of the methodologies discussed herein may be executed. For example, the instructions 810 may cause the machine 800 to execute any one or more of the methods described herein. The instructions 810 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while only a single machine 800 is illustrated, the term “machine” shall also be taken to include a collection of machines that individually or jointly execute the instructions 810 to perform any one or more of the methodologies discussed herein. The machine 800, for example, may comprise the member client device 102 or any one of a number of server devices forming part of the experience analytics server 116. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 802, which may be configured to communicate with each other via a bus 840. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 808 and a processor 812 that execute the instructions 810. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 814, a static memory 816, and a storage unit 818, both accessible to the processors 804 via the bus 840. The main memory 814, the static memory 816, and storage unit 818 store the instructions 810 embodying any one or more of the methodologies or functions described herein. The instructions 810 may also reside, completely or partially, within the main memory 814, within the static memory 816, within machine-readable medium 820 within the storage unit 818, within at least one of the processors 804 (e.g., within the processor's cache memory), or any suitable combination thereof, during execution thereof by the machine 800.

The I/O components 802 may include a wide variety of components to receive input, provide output, produce output, transmit information, exchange information, capture measurements, and so on. The specific I/O components 802 that are included in a particular machine will depend on the type of machine. For example, portable machines such as mobile phones may include a touch input device or other such input mechanisms, while a headless server machine will likely not include such a touch input device. It will be appreciated that the I/O components 802 may include many other components that are not shown in FIG. 8. In various examples, the I/O components 802 may include user output components 826 and user input components 828. The user output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 802 may include biometric components 830, motion components 832, environmental components 834, or position components 836, among a wide array of other components. For example, the biometric components 830 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 832 include acceleration sensor components (e.g., accelerometer), gravitation sensor components, rotation sensor components (e.g., gyroscope).

The environmental components 834 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 3600 camera for capturing 360° photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 836 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 802 further include communication components 838 operable to couple the machine 800 to a network 822 or devices 824 via respective coupling or connections. For example, the communication components 838 may include a network interface component or another suitable device to interface with the network 822. In further examples, the communication components 838 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 824 may be another machine or any of a wide variety of peripheral devices (e.g., a peripheral device coupled via a USB).

Moreover, the communication components 838 may detect identifiers or include components operable to detect identifiers. For example, the communication components 838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 838, such as location via Internet Protocol (IP) geolocation, location via Wi-Fi® signal triangulation, location via detecting an NFC beacon signal that may indicate a particular location, and so forth.

The various memories (e.g., main memory 814, static memory 816, and memory of the processors 804) and storage unit 818 may store one or more sets of instructions and data structures (e.g., software) embodying or used by any one or more of the methodologies or functions described herein. These instructions (e.g., the instructions 810), when executed by processors 804, cause various operations to implement the disclosed examples.

The instructions 810 may be transmitted or received over the network 822, using a transmission medium, via a network interface device (e.g., a network interface component included in the communication components 838) and using any one of several well-known transfer protocols (e.g., hypertext transfer protocol (HTTP)). Similarly, the instructions 810 may be transmitted or received using a transmission medium via a coupling (e.g., a peer-to-peer coupling) to the devices 824.

### Software Architecture

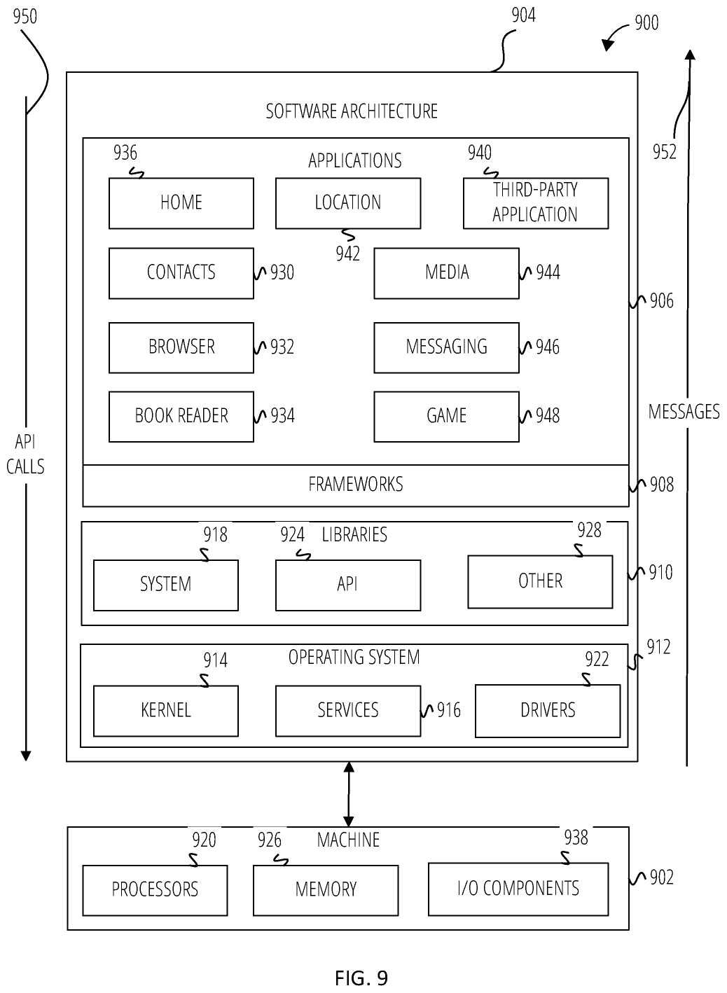

FIG. 9 is a block diagram 900 illustrating a software architecture 904, which can be installed on any one or more of the devices described herein. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionalities. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 910 provide a common low-level infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a common high-level infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In an example, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate functionality described herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving a snapshot of a webpage;
identifying a first set of targets included in the snapshot;
selecting nodes corresponding to the identified first set of targets;
determining, based on a selected metric, metrics for the selected nodes;
determining a second set of nodes by filtering a number of nodes having a highest set of values of the metrics;
generating a first set of zones based on the second set of nodes; and
providing the generated first set of zones for display on a client device.

2. The method of claim 1, further comprising:
identifying the first set of targets included in the snapshot;
determining a first set of metrics indicating a number of clicks for each of the first set of targets;
determining, from the identified first set of targets, a second set of targets corresponding to a highest number of clicks based on the determined first set of metrics; and
providing the second set of targets as a set of results of a pre-filtering process prior to performing additional data analysis.

3. The method of claim 1, wherein identifying the first set of targets included in the snapshot is based on a natural language processing process that identifies a set of elements from the snapshot.

4. The method of claim 1, further comprising:
generating a tree structure representing the first set of targets included in the snapshot, the tree structure comprising a set of nodes, the set of nodes comprising a particular node for each target from the first set of targets.

5. The method of claim 1, wherein the selected metric comprises a click rate, click recurrence, revenue, or attractiveness rate.

6. The method of claim 1, wherein filtering the number of nodes having the highest set of values of the metrics comprises removing a third set of nodes from the selected nodes, the third set of nodes having values of the selected metric that are lower than each value from the highest set of values, the second set of nodes corresponding to a set of remaining nodes after removing the third set of nodes.

7. The method of claim 1, wherein generating the first set of zones includes assigning a tag or metadata comprising information identifying each zone from the first set of zones.

8. The method of claim 1, wherein providing the generated first set of zones for display on a client device comprises generating an interface, the interface comprising a set of graphical elements representing the generated first set of zones, the set of graphical elements comprising visual indicators that highlight a set of positions of the generated first set of zones within the webpage.

9. The method of claim 2, further comprising:
selecting a particular set of nodes corresponding to the identified first set of targets; and
determining a second set of metrics for the particular set of nodes, the second set of metrics comprising a particular metric different from the selected metric.

10. The method of claim 9, further comprising:
generating a second set of zones based on the particular set of nodes; and
providing the generated second set of zones for display on the client device.

11. A system comprising:
a processor; and
a memory storing instructions that, when executed by the processor, configure the system to perform operations comprising:
receiving a snapshot of a webpage;
identifying a first set of targets included in the snapshot;
selecting nodes corresponding to the identified first set of targets;
determining, based on a selected metric, metrics for the selected nodes;
determining a second set of nodes by filtering a number of nodes having a highest set of values of the metrics;
generating a first set of zones based on the second set of nodes; and
providing the generated first set of zones for display on a client device.

12. The system of claim 11, wherein the operations further comprise:
identifying the first set of targets included in the snapshot;
determining a first set of metrics indicating a number of clicks for each of the first set of targets;
determining, from the identified first set of targets, a second set of targets corresponding to a highest number of clicks based on the determined first set of metrics; and
providing the second set of targets as a set of results of a pre-filtering process prior to performing additional data analysis.

13. The system of claim 11, wherein identifying the first set of targets included in the snapshot is based on a natural language processing process that identifies a set of elements from the snapshot.

14. The system of claim 11, wherein the operations further comprise:
generating a tree structure representing the first set of targets included in the snapshot, the tree structure comprising a set of nodes, the set of nodes comprising a particular node for each target from the first set of targets.

15. The system of claim 11, wherein the selected metric comprises a click rate, click recurrence, revenue, or attractiveness rate.

16. The system of claim 11, wherein filtering the number of nodes having the highest set of values of the metrics comprises removing a third set of nodes from the selected nodes, the third set of nodes having values of the selected metric that are lower than each value from the highest set of values, the second set of nodes corresponding to a set of remaining nodes after removing the third set of nodes.

17. The system of claim 11, wherein generating the first set of zones includes assigning a tag or metadata comprising information identifying each zone from the first set of zones.

18. The system of claim 11, wherein providing the generated first set of zones for display on a client device comprises generating an interface, the interface comprising a set of graphical elements representing the generated first set of zones, the set of graphical elements comprising visual indicators that highlight a set of positions of the generated first set of zones within the webpage.

19. The system of claim 12, wherein the operations further comprise:
selecting a particular set of nodes corresponding to the identified first set of targets; and
determining a second set of metrics for the particular set of nodes, the second set of metrics comprising a particular metric different from the selected metric.

20. The system of claim 19, wherein the operations further comprise:
generating a second set of zones based on the particular set of nodes; and
providing the generated second set of zones for display on the client device.

21. A non-transitory computer-readable storage medium, the computer-readable storage medium including instructions that when executed by a computer, cause the computer to perform operations comprising:
receiving a snapshot of a webpage;
identifying a first set of targets included in the snapshot;
selecting nodes corresponding to the identified first set of targets;
determining, based on a selected metric, metrics for the selected nodes;
determining a second set of nodes by filtering a number of nodes having a highest set of values of the metrics;
generating a first set of zones based on the second set of nodes; and
providing the generated first set of zones for display on a client device.

22. The non-transitory computer-readable storage medium of claim 21, wherein the operations further comprise:
identifying the first set of targets included in the snapshot;
determining a first set of metrics indicating a number of clicks for each of the first set of targets;
determining, from the identified first set of targets, a second set of targets corresponding to a highest number of clicks based on the determined first set of metrics; and
providing the second set of targets as a set of results of a pre-filtering process prior to performing additional data analysis.

23. The non-transitory computer-readable storage medium of claim 21, wherein identifying the first set of targets included in the snapshot is based on a natural language processing process that identifies a set of elements from the snapshot.

24. The non-transitory computer-readable storage medium of claim 21, wherein the operations further comprise:
generating a tree structure representing the first set of targets included in the snapshot, the tree structure comprising a set of nodes, the set of nodes comprising a particular node for each target from the first set of targets.

25. The non-transitory computer-readable storage medium of claim 21, wherein the selected metric comprises a click rate, click recurrence, revenue, or attractiveness rate.

26. The non-transitory computer-readable storage medium of claim 21, wherein filtering the number of nodes having the highest set of values of the metrics comprises removing a third set of nodes from the selected nodes, the third set of nodes having values of the selected metric that are lower than each value from the highest set of values, the second set of nodes corresponding to a set of remaining nodes after removing the third set of nodes.

27. The non-transitory computer-readable storage medium of claim 21, wherein generating the first set of zones includes assigning a tag or metadata comprising information identifying each zone from the first set of zones.

28. The non-transitory computer-readable storage medium of claim 21, wherein providing the generated first set of zones for display on a client device comprises generating an interface, the interface comprising a set of graphical elements representing the generated first set of zones, the set of graphical elements comprising visual indicators that highlight a set of positions of the generated first set of zones within the webpage.

29. The non-transitory computer-readable storage medium of claim 22, wherein the operations further comprise:
selecting a particular set of nodes corresponding to the identified first set of targets; and
determining a second set of metrics for the particular set of nodes, the second set of metrics comprising a particular metric different from the selected metric.

30. The non-transitory computer-readable storage medium of claim 29, wherein the operations further comprise:
generating a second set of zones based on the particular set of nodes; and
providing the generated second set of zones for display on the client device.
